(19) United States
(12) Patent Application Publication
(10) Pub. No.: US 2009/0210310 A1
(43) Pub. Date: Aug. 20, 2009

(54) DATA CODE READER

(75) Inventors: Hidemi Mihara, Shizuoka (JP); Hitoshi Iizaka, Shizuoka (JP); Yoshiya Yamada, Shizuoka (JP); Osamu Tsuchiya, Shizuoka (JP); Hidehiro Naitou, Tokyo (JP); Norihiko Kurihara, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/369,277

(22) Filed: Feb. 11, 2009

(30) Foreign Application Priority Data
Feb. 18, 2008 (JP) 2008-036315

(51) Int. Cl. G06Q 30/00; G06K 7/00

(52) U.S. Cl. 705/23; 235/435

(57) ABSTRACT

In a data code reader, an image pickup section takes an image of at least a data code attached to a commodity, a decode section decodes the data code based on image data acquired by image pickup of the image pickup section, and a data code selection guide section gives a notice to urge selection of one data code from plural data codes when determining, based on the image data acquired by the image pickup of the image pickup section or a decode result of the decode section, that the plural data codes exist.

### CROSS-REFERENCE TO RELATED APPLICATIONS

This application is based upon and claims the benefit of priority from the prior Japanese Patent Application No. 2008-036315, filed Feb. 18, 2008, the entire contents of which are incorporated herein by reference.

### TECHNICAL FIELD

The present invention relates to a commodity registration system in which the price of a commodity and the like are obtained based on a data code and the settlement process of the commodity is performed, and particularly to a data code reader for reading a data code such as, for example, a barcode attached to a commodity.

### BACKGROUND

For example, JP-A-11-306278 discloses a barcode reader which can read plural barcodes attached to commodities. JP-A-11-306278 discloses that an image of barcodes attached to commodities is taken, the number of barcodes attached to the commodities is recognized from the image data, and when the number of barcodes is one, the single barcode is recognized and is read from the image data, and when the number is plural, the plural barcodes are recognized and are read from the image data.

For example, in the case where two commodities A and B are united in one commodity C and are sold, it is sufficient that only the barcode of the commodity C is read and the commodity information of the commodity C is acquired. However, when the respective barcodes of the individual commodities A and B are also read in addition to the reading of the barcode attached to the commodity C, the commodity information, such as unit price, of the commodity C to be sold cannot be acquired, and the commodity information, such as the accurate unit price, of the commodity C cannot be acquired.

### SUMMARY

It is an object of the present invention to enable, even when plural data codes are read, acquisition of commodity information such as accurate unit price by urging selection of one data code corresponding to a commodity from the plural data codes.

According to an aspect of the invention, a data code reader includes an image pickup section that takes an image of at least a data code attached to a commodity, a decode section that decodes the data code based on image data acquired by image pickup of the image pickup section, and a data code selection guide section that gives a notice to urge selection of one data code from plural data codes when determining, based on the image data acquired by the image pickup of the image pickup section or a decode result of the decode section, that the plural data codes exist.

According a second aspect of the invention, a data code reading method includes taking an image of at least a data code attached to a commodity by an image pickup section, decoding the data code by a decode section based on image data acquired by image pickup of the image pickup section, and giving a notice to urge selection of one data code from plural data codes when a data code selection guide section determines, based on the image data acquired by the image pickup of the image pickup section or a decode result of the decode section, that the plural data codes exist.

### DESCRIPTION OF THE DRAWINGS

FIG. 1 is a perspective view showing an embodiment of a checkout lane system to which a data code reader of the invention is applied.

FIG. 2 is a specific block structural view of the data code reader and a POS terminal in the system.

FIG. 3 is a view showing an example of a guide message displayed on a casher display unit by a data code selection guide section in the system.

FIG. 4 is an operation flowchart of data code reading in the system.

FIG. 5 is an operation flowchart of a registration process in the POS terminal in the system.

FIG. 6 is a view showing a case where barcodes attached to respective commodities are not concealed by a label when the plural commodities are united.

### DETAILED DESCRIPTION

Hereinafter, an embodiment of the invention will be described with reference to the drawings.

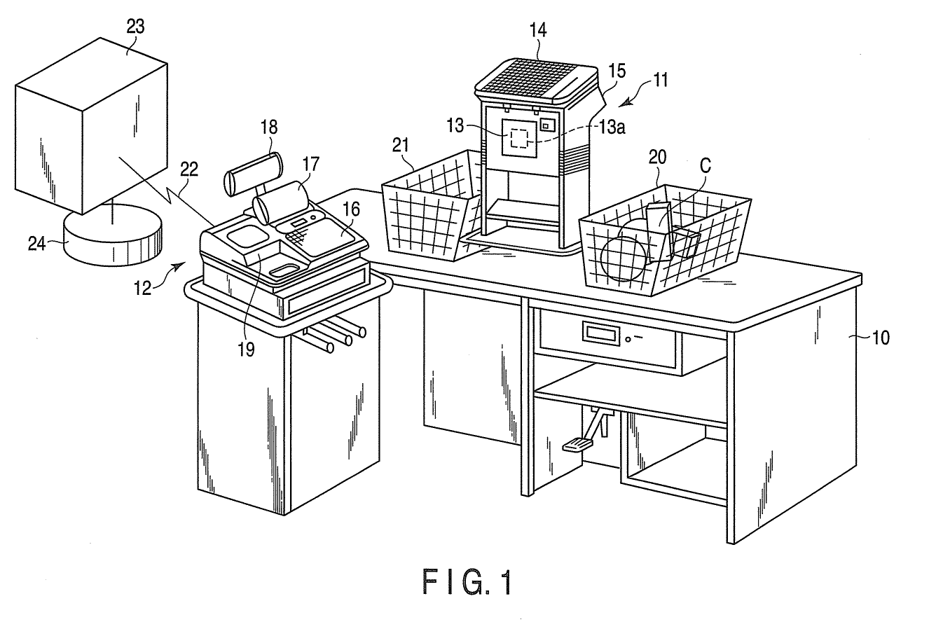

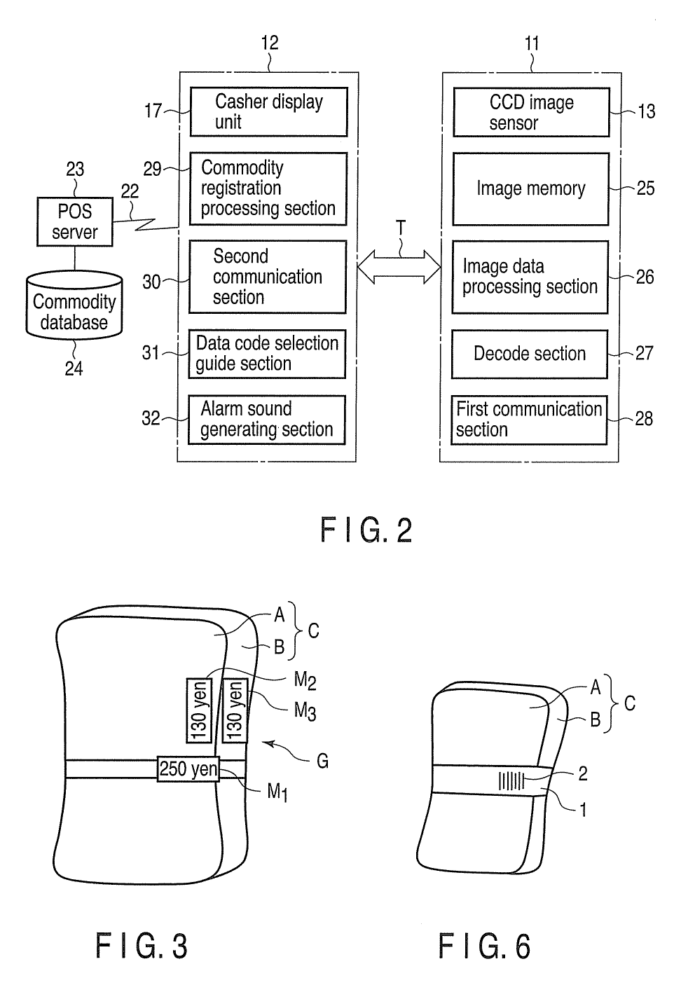

FIG. 1 is a perspective view of a checkout lane system (commodity registration system) to which a data code reader (scanner) is applied. A data code reader 11 and a POS terminal 12 are connected through a communication section T as shown in FIG. 2 so as to enable mutual communication.

The data code reader 11 is provided with an image pickup apparatus 13, a keyboard 14, a display 15 and the like. The image pickup apparatus 13 reads a data code, for example, a barcode 2 attached to a commodity C as shown in FIG. 6. The figure shows the commodity C in which two commodities A and B are united in one by a label 1 and are sold. In the commodity C, a barcode 3 attached to the commodity A and a barcode 4 attached to the commodity B are not concealed by the label 1 of the commodity C. The keyboard 14 is provided with various keys for registering a commodity which cannot be registered by reading a barcode. The display 15 displays, for example, the registered commodity name, price and the like of the commodity C to a purchaser.

The image pickup apparatus 13 includes, for example, a CCD (Charge Coupled Device) image sensor. Hereinafter, the image pickup apparatus 13 is called the CCD image sensor 13. The CCD image sensor 13 includes an illuminating device 13a including an LED. The illuminating device 13a irradiates illumination light so as to cover an image pickup area of the CCD image sensor 13.

The POS terminal 12 is provided with a keyboard 16, a casher display unit 17, a customer display unit 18, a printer 19 and the like.

The casher display unit 17 displays commodity information of the commodity C, such as registration information of the commodity C and a change amount, to the casher.

The casher display unit 17 is used also as a guide message display to the casher. The casher display unit 17 includes, for example, a liquid crystal display. In the casher display unit 17, a touch panel is formed on the display screen of the liquid crystal display or the like.

The POS terminal 12 is connected with a POS server 23 through, for example, a local area network (LAN) 22 in the store. The POS server 23 transmits and receives information relating to a settlement process of the commodity C or the like to and from the POS terminal 12, and records the result of the settlement process of the commodity C or the like. The POS server 23 includes a commodity database 24. The commodity database 24 previously stores commodity information data such as, for example, prices and commodity names of all commodities C sold in the store.

The POS server 23 refers to the commodity database for decode information transmitted from the POS terminal 12 through the LAN 22, reads data, such as price and commodity name, of the commodity C corresponding to the decode information, obtains settlement amount data, and sends back the settlement amount data to the POS terminal 12 through the LAN 22.

FIG. 2 is a specific block structural view of the data code reader 11 and the POS terminal 12. The data code reader 11 includes a computer including a CPU and the like. The data code reader 11 actuates the CCD image sensor 13, an image memory 25, an image data processing section 26, a decode section 27, and a first communication section 28 by instructions issued from the computer. The image memory 25 stores image data acquired by image pickup of the CCD image sensor 13.

The image data processing section 26 analyzes the image data stored in the image memory 25 and detects the barcode 2 included in the image data. For example, as shown in FIG. 6, when the image data includes the plural barcodes 2, 3 and 4, the image data processing section 26 detects the positions of the respective barcodes 2, 3 and 4 in the image data and acquires position information. The image data processing section 26 determines the number of barcodes included in the image data based on the number of pieces of decode information obtained from the decode result of the decode section 27 described later.

The decode section 27 decodes the barcode detected by the analysis of the image data processing section 26, and acquires the decode information. For example, when the plural barcodes 2, 3 and 4 are detected by the image data processing section 26 as shown in FIG. 6, the decode section 27 decodes the barcodes 2, 3 and 4, and acquires the respective pieces of decode information as the decode result.

The first communication section 28 communicates with a second communication section 30 of the POS terminal 12. The first communication section 28 transmits the decode information acquired by the decode section 27 to the POS terminal 12 through the communication section T. The first communication section 28 receives the respective pieces of decode information of the barcodes 2, 3 and 4 from the decode section 27. Together with this, the first communication section 28 receives the respective pieces of position information of the barcodes 2, 3 and 4 from the image data processing section 26. The first communication section 28 receives the image data of the object for which the respective pieces of decode information of the barcodes 2, 3 and 4 are acquired from the image data processing section 26. The first communication section 28 transmits the respective pieces of the received decode information, the respective pieces of position information of the barcodes 2, 3 and 4, and the image data to the POS terminal 12 through the communication section T.

The POS terminal 12 includes a computer including a CPU and the like. The POS terminal 12 actuates the casher display unit 17, a commodity registration processing section 29, the second communication section 30, a data code selection guide section 31 and an alarm sound generating section 32 by instructions issued from the computer.

The commodity registration processing section 29 sends the decode information transmitted from the data code reader 11 to the POS server 23 through the LAN 22 in the store.

The POS server 23 refers to the commodity database for the decode information sent from the commodity registration processing section 29, reads the commodity information of the commodity C corresponding to the decode information, and delivers the commodity information of the commodity C to the commodity registration processing section 29 through the LAN 22.

The commodity registration processing section 29 displays the commodity information of the commodity C on the casher display unit 17 and the customer display unit 18. The commodity registration processing section 29 sums the prices of the respective commodities C and obtains the settlement amount data.

When receiving the respective pieces of decode information of plural barcodes, for example, the barcodes 2, 3 and 4 as shown in FIG. 6 from the data code reader 11, the data code selection guide section 31 determines that the plural barcodes 2, 3 and 4 exist, and displays a guide message for giving a notice to urge selection of one barcode 2 from the barcodes 2, 3 and 4 on the casher display unit 17.

The data code selection guide section 31 displays, on the casher display unit 17, the image data of the object for which the respective pieces of the decode information of the barcodes 2, 3 and 4 are acquired. The data code selection guide section 31 displays the respective prices of the commodity information data acquired by the commodity registration processing section 29 at, for example, the respective positions corresponding to the barcodes 2, 3 and 4 in the image data. The respective positions of the barcodes 2, 3 and 4 in the image data are based on the respective pieces of position information of the barcodes 2, 3 and 4 sent from the data code reader 11.

The data code selection guide section 31 detects the commodity C selected by the casher based on a touch position signal generated when the price display of the commodity C on the touch panel of the casher display unit 17 is touched, and delivers the detected price of the commodity C to the commodity registration processing section 29. By this, the commodity registration processing section 29 performs a registration process of the price of the commodity C selected by the data code selection guide section 31.

The data code selection guide section 31 displays a guide message G on the casher display unit 17, and gives a notice to the alarm sound generating section 32 to generate an alarm sound informing that plural barcodes exist.

When receiving the notice indicating that the plural barcodes exist from the data code selection guide section 31, the alarm sound generating section 32 issues a buzzer sound such as, for example, “boo”. The alarm sound generating section 32 may generate a message, other than the buzzer sound, indicating that plural barcodes 2, 3 and 4 exist, for example, “Plural barcodes exist”.

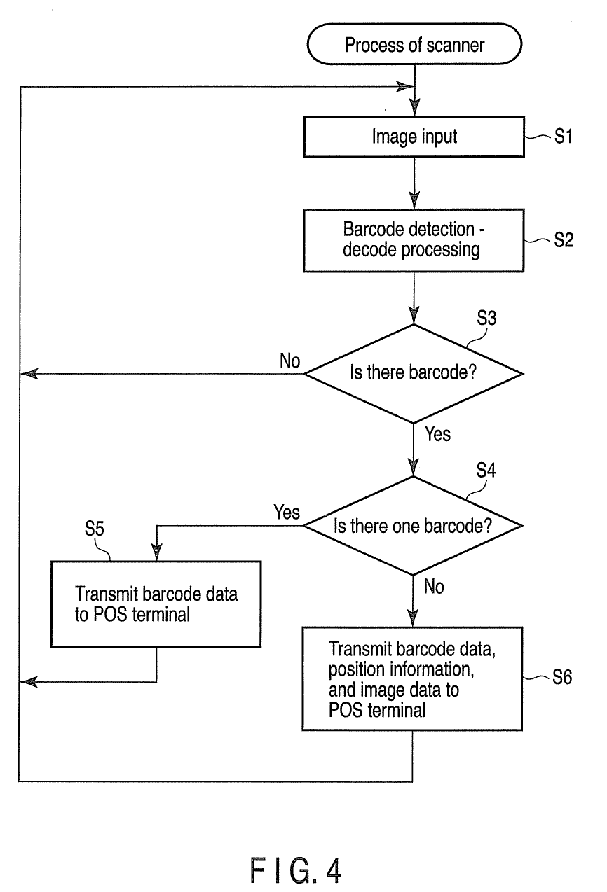

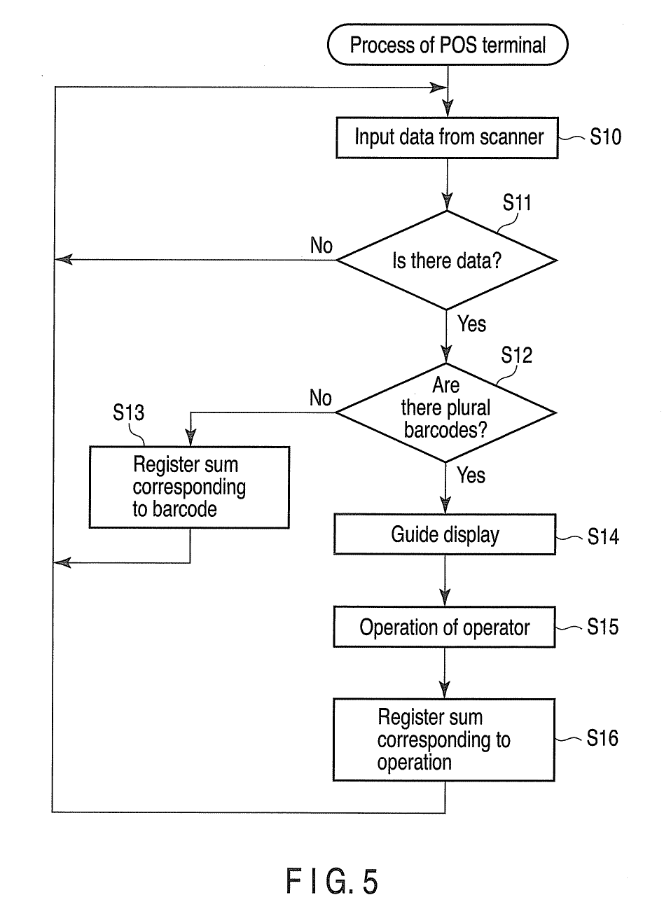

Next, a commodity registration operation of the commodity registration system constructed as stated above will be described with reference to an operation flowchart of data code reading shown in FIG. 4 and an operation flowchart of a registration process in the POS terminal shown in FIG. 5.

The casher takes out a commodity C from a shopping cart 20 and directs it to the CCD image sensor 13 in order to perform commodity registration by causing the CCD image sensor 13 of the data code reader 11 to read the barcode 2 attached to, for example, the commodity C shown in FIG. 6. The casher confirms the reading of the barcode 2 of the commodity C and puts it in another shopping cart 21.

At this time, the CCD image sensor 13 takes an image of the barcode 2 of the commodity C at Act 1 shown in FIG. 4, and outputs image data. The image data is temporarily stored in, for example, the image memory 25.

Next, the image data processing section 26 reads the image data stored in the image memory 25 at Act 2. The image data processing section 26 analyzes the image data and detects a barcode. In the case of the commodity C shown in FIG. 6, the image data processing section 26 detects the three barcodes 2, 3 and 4 in the image data.

The decode section 27 decodes the three barcodes 2, 3 and 4 detected by the image data processing section 26, and acquires three pieces of decode information.

The image data processing section 26 receives the decode information of the decode section 27 at Act 3 and determines that the barcodes exist.

Next, the image data processing section 26 determines at Act 4 that plural barcodes exist since the three pieces of decode information of the decode section 27 exist.

When determining that the plural barcodes exist, the image data processing section 26 detects the positions of the barcodes 2, 3 and 4 in the image data detected at Act 2, and acquires the respective pieces of position information.

Next, the first communication section 28 shifts to Act 6, and transmits the respective pieces of decode information of the three barcodes 2, 3 and 4 attached to the commodity C acquired by the decode section 27, the respective pieces of position information of the barcodes 2, 3 and 4, and the image data to the POS terminal 12 through the communication section T.

On the other hand, at Act 10 shown in FIG. 5, when receiving the respective pieces of decode information of the three barcodes 2, 3 and 4 from the data code reader 11 through the second communication section 30, the POS terminal 12 delivers the respective pieces of decode information to the commodity registration processing section 29.

Next, at Act 11, when receiving the respective pieces of decode information from the data code reader 11 through the second communication unit 30, the commodity registration processing section 29 shifts to Act 12, and determines whether plural pieces of decode information exist. Here, since the commodity registration processing section 29 receives the respective pieces of decode information of the three barcodes 2, 3 and 4 of the commodity C as shown in FIG. 6, it is determined at Act 12 that the three barcodes 2, 3 and 4 exist.

When determining that the respective pieces of decode information of the three barcodes 2, 3 and 4 of the commodity C exist, the commodity registration processing section 29 delivers the information informing that the respective pieces of decode information of the three barcodes 2, 3 and 4 exist to the data code selection guide section 31.

Next, when receiving the information informing that the plural pieces of decode information exist from the commodity registration processing section 29, the data code selection guide section 31 displays, on the casher display unit 17, the guide message G for giving a notice to urge selection of one barcode 2 from the barcodes 2, 3 and 4.

The data code selection guide section 31 displays the guide message G and gives a notice to the alarm sound generating section 32 to generate an alarm sound informing that the plural barcodes 2, 3 and 4 exist. By this, the alarm sound generating section 32 generates a buzzer sound such as, for example, “boo” to indicate that the plural barcodes 2, 3 and 4 exist. Alternatively, the alarm sound generating section 32 may generate a message, other than the buzzer sound, indicating that the plural barcodes 2, 3 and 4 exist, for example, “Plural barcodes exist”.

By this, as shown in FIG. 3, the data code selection guide section 31 displays the image data acquired by image pickup of the CCD image sensor 13 on the casher display unit 17. Together with this, the data code selection guide section 31 displays prices M1, M2 and M3 at the respective positions corresponding to the barcodes 2, 3 and 4 in the image data acquired by the image pickup of the CCD image sensor 13.

The price M1 is the original price “250 yen” of the commodity C. The price M2 is the price “130 yen” of the commodity A constituting the commodity C. The price M3 is the price “130 yen” of the commodity B constituting the commodity C. The respective positions of the barcodes 2, 3 and 4 in the image data can be determined based on the respective pieces of position information of the barcodes 2, 3 and 4 sent from the data code reader 11.

The display positions of the prices M1, M2 and M3 corresponding to the barcodes 2, 3 and 4 may be displayed to overlap with the barcodes 2, 3 and 4. The display positions of the prices M1, M2 and M3 may be displayed adjacent to the barcodes 2, 3 and 4.

The respective prices M1, M2 and M3 corresponding to the barcodes 2, 3 and 4 in the image data are acquired, for example, in a manner as described below. The commodity registration processing section 29 sends the respective pieces of decode information of the barcodes 2, 3 and 4 to the POS server 23 through the LAN 22 in the store.

The POS server 23 refers to the commodity database for the respective pieces of decode information sent from the commodity registration processing section 29, and reads the commodity information, such as prices and commodity names, corresponding to the decode information. The POS server 23 delivers the commodity information, such as the prices, read from the commodity database to the commodity registration processing section 29 through the LAN 22. By this, the commodity registration processing section 29 acquires the prices M1, M2 and M3 corresponding to the barcodes 2, 3 and 4 from the commodity information sent to the POS server 23.

Next, the data code selection guide section 31 waits for the input of a touch position signal outputted from the touch panel of the casher display unit 17 at Act 15. The casher touches the original price “250 yen” of the commodity C on the display screen of the casher display unit 17 by a finger or the like in order to select the original price M1 of the commodity C from the prices M1, M2 and M3, that is, the price “250 yen” from the guide message G displayed on the display screen of the casher display unit 17 as shown in FIG. 3.

When the original price “250 yen” on the touch panel of the display screen of the casher display unit 17 is touched by the finger, at Act 15, the touch panel outputs the touch position signal corresponding to the touch position. The touch position signal is delivered to the data code selection guide section 31.

At Act 16, the data code selection guide section 31 determines based on the touch position signal from the touch panel of the casher display unit 17 that the original price “250 yen” of the commodity C is selected. As a result of the determination, the data code selection guide section 31 delivers the original price “250 yen” of the commodity C to the commodity registration processing section 29.

By this, the commodity registration processing section 29 displays the commodity information, such as the original price “250 yen” of the commodity C and the commodity name, on the casher display unit 17 and the customer display unit 18.

As stated above, according to the embodiment, when it is determined that plural barcodes, for example, the barcodes 2, 3 and 4 exist in the image data acquired by image pickup of the CCD image sensor 13, the guide message G for urging selection of one barcode from the barcodes 2, 3 and 4 is displayed.

By the display of the guide message G, one barcode, that is, the original price M1 (250 yen) of the barcode 2 of the commodity C can be selected from the barcodes 2, 3 and 4.

The guide message G is displayed on the display screen of the casher display unit 17. That is, the casher display unit 17 generally displays commodity information of the commodity C, such as registration information of the commodity C and a change amount, to the casher. At the time of the registration process of the commodity C, the casher always sees the commodity information of the commodity C, such as the registration information of the commodity C and the change amount, displayed on the casher display unit 17.

Accordingly, the casher can immediately confirm that the guide message G is displayed on the casher display unit 17. By this, the casher can select the original price M1 (250 yen) of the barcode 2 of the commodity C by using the guide message G, and can improve the operation efficiency of the commodity registration.

The casher can select the original price M1 (250 yen) of the barcode 2 of the commodity C by merely seeing the guide message G.

Together with the display of the guide message G, the alarm sound generating section 32 generates a buzzer sound or the like indicating that the plural barcodes 2, 3 and 4 exist. It is possible to urge the casher to select one barcode 2 from the plural barcodes 2, 3 and 4.

For example, the determination that plural barcodes, for example, the barcodes 2, 3 and 4 exist in the image data acquired by image pickup of the CCD image sensor 13 may be performed by the image data processing section 26 and by detection of the respective barcodes 2, 3 and 4 included in the image data.

For example, the invention can also be applied to a case where when labels reciting plural barcodes are erroneously attached to one commodity C, the price of a correct barcode attached to the commodity C is selected from the respective prices of the barcodes.

The invention is not limited to a barcode attached to a commodity and can also be applied to a case where a QR code is attached.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data code reader comprising:
an image pickup section that takes an image of at least a data code attached to a commodity;
a decode section that decodes the data code based on image data acquired by image pickup of the image pickup section; and
a data code selection guide section that gives a notice to urge selection of one data code from a plurality of data codes when determining, based on the image data acquired by the image pickup of the image pickup section or a decode result of the decode section, that the plurality of data codes exist.

2. The apparatus according to claim 1, wherein the data code selection guide section displays respective prices corresponding to the plurality of data codes, and enables one price of the prices to be selected.

3. The apparatus according to claim 2, wherein the data code selection guide section displays the image data acquired by of the image pickup of the image pickup section, and displays the respective prices at respective positions corresponding to the plurality of data codes in the image data.

4. The apparatus according to claim 4, wherein the data code selection guide section displays the respective prices on a display and informs, by a sound, that the plurality of data codes exist.

5. A data code reading method comprising:
taking an image of at least a data code attached to a commodity by an image pickup section;
decoding the data code by a decode section based on image data acquired by image pickup of the image pickup section; and
giving a notice to urge selection of one data code from a plurality of data codes when a data code selection guide section determines, based on the image data acquired by the image pickup of the image pickup section or a decode result of the decode section, that the plurality of data codes exist.
